(19) United States
(12) Patent Application Publication
(10) Pub. No.: US 2026/0244767 A1
(43) Pub. Date: Aug. 20, 2026

(54) System and method for secure operation of cloud applications

(71) Applicant: Bank of America Corporation, Charlotte, NC (US)

(72) Inventors: Sudha Davuluri, Simi Valley, CA (US); Kalyan Chakravarthy Pallapolu, Hyderabad (IN)

(21) Appl. No.: 19/053,775

(22) Filed: Feb. 14, 2025

(51) Int. Cl. G06F 21/60; H04L 9/00; H04L 9/14

(52) U.S. Cl. CPC G06F 21/602; H04L 9/14; H04L 9/50

(57) ABSTRACT

A system includes a memory storing a hashing algorithm, a private key, and a generative AI model and a processor coupled to the memory. The processor executes the generative AI model on an input file to determine a first cloud application to invoke, transmits the input file to the first cloud application, detects an activation of a data interaction by the first cloud application, and executes the generative AI model on the data interaction to generate a structured output including an indication of a second cloud application to invoke by the data interaction. The processor translates the structured output into code of a secured computer program, executes the hashing algorithm and private key to encrypt the data interaction, and transmits the encrypted data interaction to the secured computer program for validation. The processor further transmits the validated data interaction to the second cloud application for execution.

### TECHNICAL FIELD

The present disclosure relates generally to operating cloud applications, and more specifically, to secure operation of cloud applications.

### BACKGROUND

In a cloud multi-tenant architecture, many applications often utilize the same server, typically separated by partitions to mitigate data sharing or migration risks between applications. When multiple applications belong to the same organization, real-time data interactions may occur between these applications.

### SUMMARY

Conventional systems enable data interactions between cloud applications without considering the inherent risks regarding the content and intended target cloud application of a data interactions. When a data interaction has confidential and/or sensitive information, the inherent risks can include leaking such confidential and/or sensitive information to unintended target cloud application, which can further cause data breach, data manipulation (manipulated data can compromise decision-making and system functionality), security threat (leaked confidential and/or sensitive data may be used in security attacks), and loss of data control. In addition, conventional systems are limited in real-time decisioning of the target cloud application and corresponding triggers to activate for a data interaction, especially considering that data files are usually from multiple source systems. Limited real-time decisioning could cause delay in transmitting a data interaction to a target cloud application, which can further increase latency and cause performance bottlenecks in the cloud computing system. If the data interaction is in a queue, the delay can cause unnecessary memory and CPU consumption. Conventional systems further fail to notify the target cloud application the purpose of the data interaction and the appropriate actions the target cloud application should take. As a result, the target cloud application may need further analysis of the data interaction to determine what operations should be conducted on the data interaction, which can cause increased latency and performance bottlenecks in the cloud computing system. Similarly, if the data interaction is in a queue, the delay can cause unnecessary memory and CPU consumption.

The system disclosed in the present application provides a technical solution to the problems discussed above. The disclosed system can securely share data interactions among cloud applications using generative artificial-intelligence (AI) models and secured computer programs on blockchain. When an input file is received from a source system, the generative AI model will analyze the input file and determine what cloud application should be invoked, along with triggers to be activated by the cloud application. Once the input file is sent to the cloud application, corresponding triggers will get activated and data operations will happen within the cloud application. Once the data operations are completed, the generative AI model can determine the complexity of the data interaction, what target cloud application the data interaction will invoke, and the approver for the targe cloud application. The disclosed system then use the output from the generative AI model to generate a secured computer program. The secured computer program will be executed automatically, which will validate the data interaction. Upon validation, the data interaction will be sent to the approver. Once the approver approves the data interaction in the targe cloud application, the target cloud application will be invoked to execute the data interaction.

In an embodiment, the disclosed system includes a memory operable to store a hashing algorithm, a private key, and a generative artificial-intelligence (AI) model. The disclosed system also includes a processor operably coupled to the memory. The processor is configured to receive, from a source system, an input file. The processor is then configured to execute the generative AI model on the input file to generate a descriptive output. The descriptive output includes an indication of a first cloud application to invoke. The first cloud application operates on a cloud computing system. The processor is then configured to transmit the input file to the first cloud application. The processor is then configured to detect an activation of a data interaction by the first cloud application. The processor is then configured to execute the generative AI model on the data interaction to generate a structured output. The structured output includes an indication of a second cloud application to invoke by the data interaction and one or more rules associated with the data interaction. The second cloud application operates on the cloud computing system. The processor is then configured to generate a secured computer program by translating the structured output into code of the secured computer program using a programming language. The secured computer program operates on a blockchain network. The processor is then configured to execute the hashing algorithm and the private key to encrypt the data interaction. The processor is then configured to transmit the encrypted data interaction to the secured computer program to execute the secured computer program on the blockchain network using the one or more rules. The execution includes validating the encrypted data interaction. The processor is further configured to, responsive to determining the encrypted data interaction is validated, transmit the data interaction to the second cloud application for execution.

In an embodiment, the descriptive output further includes one or more triggers to be activated on the first cloud application. The processor of the disclosed system is further configured to activate the one or more triggers on the first cloud application. The one or more triggers are configured to cause the first cloud application to execute one or more operations and activate the data interaction upon completing the execution of the one or more operations.

In an embodiment, the processor of the disclosed system is further configured to execute the hashing algorithm on the data interaction to generate a first hash for the data interaction. The processor is also configured to encrypt the data interaction by encrypting the first hash using the private key.

In an embodiment, validating the encrypted data interaction includes decrypting the encrypted data interaction using a public key to generate a second hash, comparing the first hash with the second hash, and validating the encrypted data interaction upon determining the first hash matches the second hash.

In an embodiment, the secured computer program further includes an identifier of an approver associated with the second cloud application. The processor of the disclosed system is further configured to transmit, to a user device associated with the approver based on the identifier, a request for an approval of invoking the second cloud application to execute the data interaction upon validating the encrypted data interaction. The processor is then configured to transmit the data interaction to the second cloud application for execution upon detecting the approval from the approver.

In an embodiment, the memory is further operable to store a database. The processor of the disclosed system is further configured to store the descriptive output in the database.

The disclosed system and methods provide the practical application of securely and effectively sharing data interactions among cloud applications in a cloud computing system. Conventional systems enable data interactions shared between cloud applications without considering the security of the content of the data interaction. Additionally, conventional systems are unable to determine the target cloud application a data interaction shared to, leading to potential delays and inaccuracies in sharing data interactions. Furthermore, conventional systems fail to notify the target cloud application the purpose of the data interaction and the appropriate actions the target cloud application should take. The disclosed system and methods can address such problems by using a generative AI model to determine the target cloud application in real time, validating encrypted data interactions on blockchain using secured computer programs, and transmitting the validated data interaction to the target cloud application. Using the generative AI model to determine the target cloud application in real time can reduce latency and prevent performance bottlenecks in the cloud computing system and save memory and CPU consumption as the data interaction does not need to be queued. Validating encrypted data interactions on blockchain can improve security of the data interaction, efficiency of the validation due to automatic self-execution, and less computing resources as validations are executed only when triggered. As described in example embodiments of the present disclosure, the disclosed system and methods use a generative AI model to analyze an input file from a source system and determine what cloud application should be invoked, along with triggers to be activated by the cloud application. The generative AI model is trained on a large-scale training dataset, ensuring the generative AI model can accurately determine a cloud application and triggers to be activated in real time. The activated cloud application performs data operations on the input file responsive to the triggers, which lead to the sharing of a data interaction. The disclosed system and methods further execute the generative AI model to determine what target cloud application the data interaction will invoke and the approver for the targe cloud application. Training the generative AI model on the large-scale training dataset can ensure the generative AI model can accurately determine the target cloud application and the approver in real time. The disclosed system and methods then use an auto-executed secured computer program to validate encrypted data interaction on blockchain, which can enhance the security of the content of the data interaction. Once validated and approved, the data interaction is shared to the target cloud application for execution.

Technical advantages of certain embodiments of this disclosure may include one or more of the following. By using use a generative AI model to analyze an input file and determine what cloud application and triggers should be invoked, the disclosed system and methods can ensure that cloud application and triggers are identified accurately in real time. Identifying cloud application and triggers accurately in real time can ensure the input file be executed in the identified cloud application efficiently without waiting in a queue, thereby reducing latency and eliminating performance bottlenecks in system operations. In addition, as the execution of input file is not queued, memory and CPU consumption can be reduced. For example, the generative AI model can be trained from a large-scale training dataset including historical data collected from all cloud applications, API interactions between the cloud applications, logs of the cloud applications responsive to different input files. The training process can correlate different cloud applications and triggers being invoked with different input files and enable the generative AI model to identify such correlation in inference stages. By using the generative AI model to determine what target cloud application the data interaction will invoke and the approver for the targe cloud application, the disclosed system and methods can ensure that target cloud applications and approvers are identified accurately in real time. Identifying target cloud applications and approvers accurately in real time can ensure the data interaction be executed in the target cloud application efficiently without waiting in a queue, thereby reducing latency and eliminating performance bottlenecks in system operations. In addition, as the execution of data interaction is not queued, memory and CPU consumption can be reduced. Furthermore, efficient execution of the data interaction in the target cloud application can result in efficient completion of the operation on the input file from the source system, thereby efficiently releasing computing resources for handling other input files from the source system. For example, the large-scale training dataset additionally includes workflow data, e.g., historical information of movement of data interactions between cloud applications. Training the generative AI model from such training dataset can enable the generative AI model to identity correlations between data interactions and target cloud application and between data interactions and approvers. By encrypting data interactions into encrypted data interactions using hashing algorithms and private keys, the disclosed system and methods can ensure that the operation of data interactions (e.g., validation and sharing) remains secure. Secured operation of data interactions can protect critical system configurations and databases associated with the data interactions to prevent system crashes and failures. Secured operation of data interactions can also minimize risks of security threats due to potential data breach of the data interactions. For example, hashing algorithms and private keys can safeguard the data interaction against potential malicious attacks. By using secured computer program to automatically validate sharing of data interactions, the disclosed system and methods can ensure security (i.e., the secured computer program cannot be tampered), reduction of a single point of failure (because the secured computer program executes in a decentralized blockchain network), and efficiency (i.e., the secured computer program executes automatically when rules are satisfied). The secured computer program can prevent attacks to the data interaction and unauthorized access to the rules used to validate the data interaction, which can further improve the system stability. In addition, the secured computer program executes in a decentralized blockchain network including multiple nodes. In case that the node where the secured computer program is executing fails, the execution of the secured computer program can be quickly migrated to another node to continue, thereby preventing a single point of failure. Furthermore, the secured computer program consumes fewer computing resources as it is executed only when triggered. Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of a system that is configured for securely sharing interactions among cloud applications.

FIGS. 2A-2B illustrate an example flowchart of a method for securely sharing interactions among cloud applications.

### DETAILED DESCRIPTION

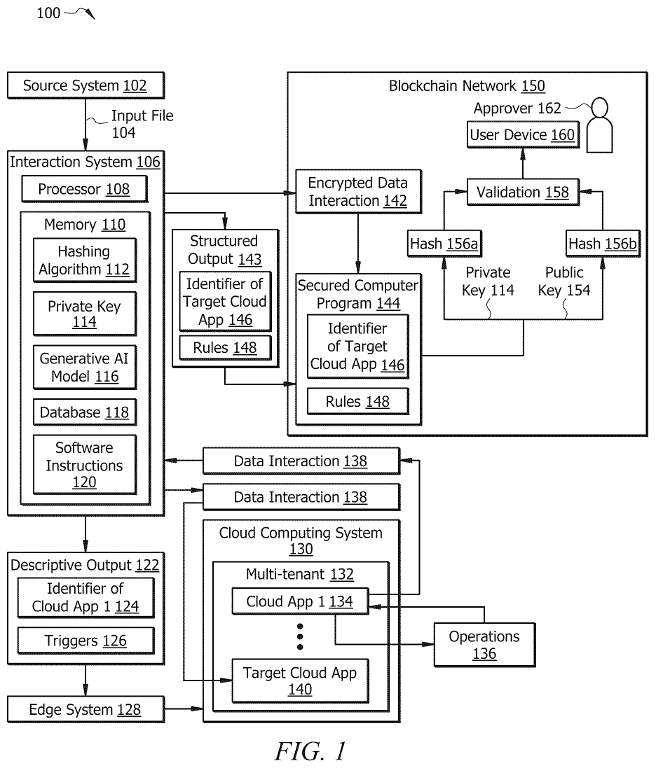

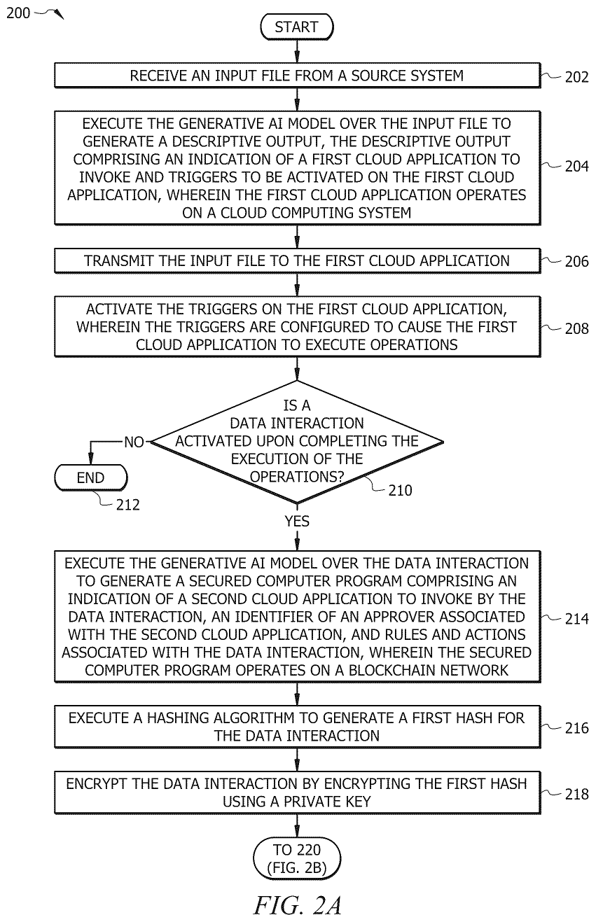

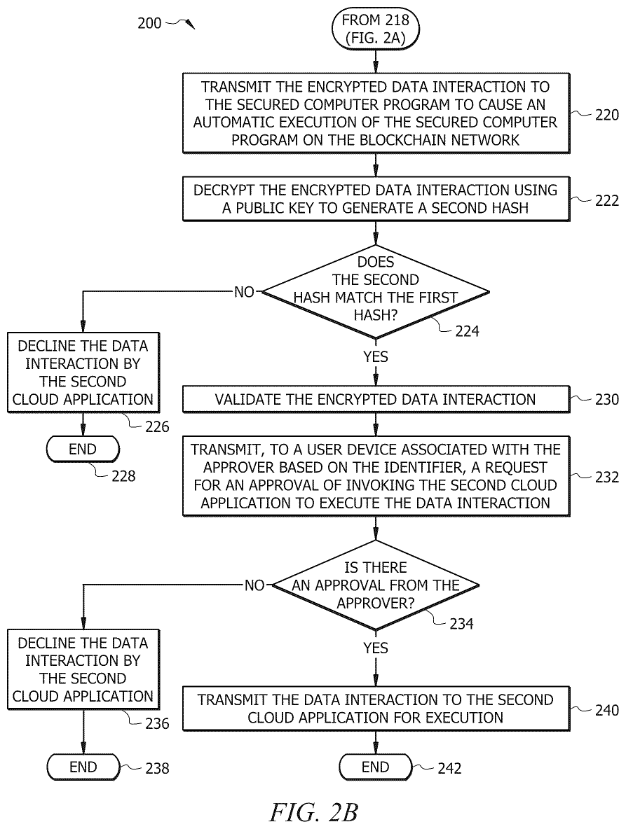

As described above, conventional systems enable data interactions between cloud applications without considering the inherent risks, are limited in real-time decisioning, and fail to communicate the purpose of the data interaction and the appropriate actions. This disclosure provides various systems and methods to manage user data stored in containers in a distributed cloud computing environment securely and efficiently. FIG. 1 illustrates one embodiment of a system that is configured for securely sharing interactions among cloud applications. FIGS. 2A-2B illustrate an example flowchart of a method for securely sharing interactions among cloud applications.

### Example System for Securely Sharing Interactions Among Cloud Applications

FIG. 1 illustrates one embodiment of a system 100 that is configured for securely sharing interactions among cloud applications. System 100 comprises a source system 102, an interaction system 106, an edge system 128, a cloud computing system 130, a blockchain network 150, a user device 160 associated with an approver 162. In some embodiments, system 100 may not have all of the components listed and/or may have other elements instead of, or in addition to, those listed above.

### Architecture Components

### Source System

Source system 102 is generally any device that is configured to process data and communicate with devices, systems (e.g., interaction system 106), etc. Source system 102 is generally an upstream system that accesses data from multiple sources and in multiple files and then sends the data to interaction system 106. For example, the multiple sources may include different applications or systems. As another example, the data may include user information, entity information, interaction data, metadata associated with the interaction data, and so on.

### Interaction System

Interaction system 106 is generally any device that is configured to process data and communicate with devices, systems (e.g., edge system 128, cloud computing system 130, blockchain network 150), etc. Interaction system 106 is generally configured to perform operations described further below in conjunction with method 200 described in FIGS. 2A-2B. In an embodiment, interaction system 106 comprises processor 108 in signal communication with a memory 110.

Processor 108 comprises one or more processors operably coupled to the memory 110. Processor 108 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). Processor 108 may be a programmable logic device, a microcontroller, a microprocessor, or any suitable combination of the preceding. Processor 108 is communicatively coupled to and in signal communication with memory 110. Processor 108 is configured to process data. For example, processor 108 may be 8-bit, 16-bit, 32-bit, 64-bit or of any other suitable architecture. Processor 108 may include an arithmetic logic unit (ALU) for performing arithmetic and logic operations, processors register that supply operands to the ALU and store the results of ALU operations, and a control unit that fetches software instructions 120 from memory 110 and executes them by directing the coordinated operations of the ALU, registers and other components. Processor 108 is configured to implement various software instructions 120. For example, processor 108 is configured to execute software instructions 120 to implement the functions disclosed herein, such as some or all of those described with respect to FIGS. 1-2. In some embodiments, the function described herein is implemented using logic units, FPGAs, ASICs, DSPs, or any other suitable hardware or electronic circuitry.

Memory 110 may be volatile or non-volatile and may comprise a read-only memory (ROM), random-access memory (RAM), ternary content-addressable memory (TCAM), dynamic random-access memory (DRAM), and static random-access memory (SRAM). Memory 110 may be implemented using one or more disks, tape drives, solid-state drives, and/or the like. Memory 110 is operable to store the software (e.g., hashing algorithm 112 and generative AI model 116), and/or any other data (e.g., private key 114 and database 118) or software instructions 120.

Generative AI model 116 is trained on a training dataset comprising a plurality of training data. The training data may be generated from historical data collected from all applications in the cloud computing system 130, API interactions between the cloud applications, and logs associated with the cloud applications. The training data may be generated additionally from workflow data, e.g., historical information of movement of data between cloud applications, either manually or through any automated process. The plurality of training data may be labeled. Once the training data are generated, interaction system 106 can train the generative AI model 116 for accurate trigger decisions, predictions of target cloud applications, interaction types, etc. The size of the training dataset is in large scale. To improve efficiency, interaction system 106 may periodically compress the training dataset and generate indexes for the training data to improve query efficiency.

In an embodiment, generative AI model 116 is trained to determine what cloud application should be invoked, along with triggers 126 to be activated. Generative AI model 116 is trained on labeled training datasets where applications and triggers are explicitly linked to interactions. For example, a training data may include user data, user data profile, data type, and trigger. The combination of user data and user data profile can help trained generative AI model 116 determine a cloud application 140 and data type may help trained generative AI model 116 determine what triggers 126 to be activated.

Generative AI model 116 is also trained to determine a target cloud application 140 and a relevant approver 162 when there is a data interaction 138 being shared from a source cloud application to the target cloud application 140. For example, to train the generative AI model 116 to be able to determine approvers, interaction system 106 may use historical approval workflows as training data. Continuing with the training data including user data, user data profiles, data types, and triggers, the training data may further include approver types/roles. As such, the trained generative AI model 116 may send specific approver type/role to edge system 128 so that edge system 128 will have details of who is the approver 162 for a particular cloud application.

In an embodiment, hashing algorithm 112 and private key 114 can be used to encrypt data interactions 138. In an embodiment, database 118 can used to store execution results of secured computer program 144.

Software instructions 120 may comprise any suitable set of instructions, logic, rules, or code operable to execute processor 108. Software instructions 120, when executed by processors 108, cause processor 108 to perform one or more functions described herein. For example, when software instructions 120 are executed, processor 108 executes generative AI model 116 to analyze an input file 104 and provide descriptive output 122 to edge system 128 on what cloud application should be invoked, along with triggers 126 to be fired. When software instructions 120 are executed, processor 108 further executes generative AI model 116 to determine the target cloud application 140 and approver 162 for a shared data interaction 138. When software instructions 120 are executed, processor 108 further execute software instructions 120 to transmit data interaction 138 to the target cloud application 140 for execution responsive to determining the data interaction 138 is validated from the execution of the secured computer program 144 on blockchain network 150.

### Edge System

Edge system 128 is a distributed computing model that processes data close to where the data is collected. Edge system performs data processing locally, which can improve application performance and reduce network load.

In an embodiment, edge system 128 may receive descriptive output 122 from interaction system 106. Edge system 128 may process descriptive output 122, determine which cloud application to invoke, and send input file 104 to the cloud application to be invoked in cloud computing system 130.

### Cloud Computing System

Cloud computing system 130 may offers network services (e.g., cloud applications). Examples of the network services may include an infrastructure-as-a-service (IaaS), a platform-as-a-service (PaaS), a software-as-a-service (SaaS), and managed services. Cloud computing system 130 may comprise a multi-tenant 132. Multi-tenant 132 may comprise a single cloud infrastructure where multiple enterprise users (referred as “tenants”) can share the same computing resources. However, the data of these enterprise users remains separate and isolated. Multi-tenant 132 is a common architecture for Software-as-a-Service (SaaS) applications, allowing cloud providers to efficiently manage and scale services for enterprise users while maintaining data privacy for each tenant.

In an embodiment, a plurality of cloud applications in multi-tenant 132 may receive and process input files 104. For example, cloud app 1 134 may be responsible for processing an input file 104. Processing an input file 104 may include operations 136 on the input file 104.

### Blockchain Network

Blockchain network 150 generally is an open, decentralized and distributed digital ledger consisting of records called blocks that are used to record data interactions across many computing nodes. Each computing node of blockchain network 150 may maintain a copy of the blockchain ledger. Logically, blockchain network 150 is a chain of blocks which contains specific information.

Blockchain network 150 may store secured computer programs 144. A secured computer program 144 may be a self-executing program that automatically performs actions defined within the code based on predetermined conditions without human intervention. Once deployed on a blockchain network 150, the code of a secured computer program 144 cannot be altered or tampered with. As shown in FIG. 1, secured computer program 144 may include an identifier 146 of a target cloud application 140 and rules 148. Secured computer program 144 may be automatically executed on blockchain network 150 according to the rules 148.

In an embodiment, an approver 162 may use user device 160 to perform operations on blockchain network 150, such as approving or declining a request to share interactions to a target cloud application 140.

### User Device

Examples of user device 160 include, but are not limited to, computers, laptops, mobile devices (e.g., smart phones or tablets), servers, clients, or any other suitable type of device associated with approver 162. User device 160 is generally configured to capture data and send instructions for processing the data to blockchain network 150 and/or source system 102, interaction system 106, or cloud computing system 130. For example, the instructions from user device 160 to blockchain network 150 may comprise an approval for a request to share a data interaction 138 to a target cloud application 140. As another example, the data to user device 160 from blockchain network 150 may comprise a request to approve sharing a data interaction 138 to a target cloud application 140. In other examples, the data may comprise any suitable type of data. The instructions may comprise any suitable type or number of commands for processing the data.

### Operational Flow

Source system 102 sends input file 104 to interaction system 106. Input file 104 may include data from multiple sources, such as user information and interaction data.

When interaction system 106 receives input file 104, interaction system 106 may preprocess input file 104, such as conducting file validation (e.g., checking format or compatibility) and embedding input file 104 into a feature representation. Interaction system 106 may additionally perform operations such as parsing (extracting content from input file 104).

Interaction system 106 may then execute generative AI model 116 over preprocessed input file 104 to analyze input file 104. For example, generative AI model 116 may include a large language model (LLM). Based on the analysis, generative AI model 116 may generate descriptive output 122. Descriptive output 122 may include the identifier 124 of cloud application 1 134, which is the cloud application to be invoked for executing input file 104. Descriptive output 122 may additionally include triggers 126 to be activated on cloud application 1 134.

Interaction system 106 may provide descriptive output 122 on what cloud application should be invoked along with triggers 126 to be activated to edge system 128. Edge system 128 may process descriptive output 122 close to where it is received. Edge system 128 may further transmit input file 104 along with descriptive output 122 to cloud application 1 134 in cloud computing system 130.

Once cloud application 1 134 receives input file 104, corresponding triggers 126 may get activated. Triggers 126 may cause cloud application 1 134 to conduct data operations 136 on input file 104 within the application along with storing descriptive output 122 (e.g., in database 118) for tracking and logging purposes.

Once the data operations 136 are completed, cloud application 1 134 may determine a data interaction 138 should be shared to another cloud application for execution of the data interaction 138. Accordingly, cloud application 1 134 may invoke generative AI model 116 and send the data interaction 138 to generative AI model 116.

Interaction system 106 may preprocess the data interaction 138. For example, interaction system 106 may denoise and normalize data interaction 138. Interaction system 106 may further execute generative AI model 116 over the data interaction 138 to determine the complexity of the data interaction 138. Generative AI model 116 may also determine a target cloud application 140 to share the data interaction 138 to for execution.

In an embodiment, generative AI model 116 may generate a structured output 143 comprising the identifier 146 of the target cloud application 140 and approver 162 responsible for approving the sharing of data interaction 138 to target cloud application 140. In some embodiments, approver 162 may be a computing node operating on blockchain network 150 that can automatically determine whether to approve or decline the sharing of data interaction 138.

Interaction system 106 may execute hashing algorithm 112 over data interaction 138 generate a hash for data interaction 138. Interaction system 106 may further encrypt the hash using private key 114 to generate encrypted data interaction 142.

Interaction system 106 may generate a secured computer program 144 based on encrypted data interaction 142. In an embodiment, interaction system 106 may translate the structured output 143 into code of the secured computer program 144. Based on the structured output 143 and the platform of the blockchain network 150, interaction system 106 may determine the structure of the secured computer program 144, including one or more of a state variable, a function, a modifier, or an event. Interaction system 106 may further map the structured output 143 to the code of the secured computer program 144 according to the structure of the secured computer program 144. For example, the encrypted data interaction 138 may be mapped to the state variables and the rules 148 may be mapped to functions. Secured computer program 144 can be then deployed to blockchain network 150. Secured computer program 144 may include the identifier 146 of the target cloud application and rules 148. Secured computer program 144 may be automatically executed on blockchain network 150 according to the rules 148.

The automatic execution of secured computer program 144 on blockchain network 150 may lead to validation 158 of the sharing of data interaction 138. In an embodiment, for validation, private key 114 may be used on encrypted data interaction 142 to obtain hash 156a; public key 154 may be used on encrypted data interaction 142 to obtain another hash 156b. Hash 156a and hash 156b may be compared during validation 158. If they match, the data interaction 138 is validated and then sent to user device 160 for approval of sharing to target cloud application 140 by approver 162. In another embodiment, after the data interaction 138 is validated, it may be sent to a computing node of blockchain network 150 that can automatically approve the sharing of data interaction 138 to target cloud application 140.

In an embodiment, validation results may be then stored to database 118. Validation results may contain the details of the target cloud application 140 and approver 162.

Once the sharing of data interaction 138 to target cloud application 140 is approved, data interaction 138 may be transmitted to target cloud application, which may be invoked to execute the data interaction 138.

After the execution of data interaction 138 is completed in target cloud application 140, cloud application 1 134 may determine whether any further data interaction 138 needs to be shared to another cloud application. If so, generative AI model 116 is again invoked, and above operational flow will be executed again.

### Example Methods for Securely Sharing Interactions Among Cloud Applications

FIGS. 2A-2B illustrate an example flowchart of a method 200 for securely sharing interactions among cloud applications. Modifications, additions, or omissions may be made to method 200. Method 200 may include more, fewer, or other operations. For example, operations may be performed in parallel or in any suitable order. While at times discussed as interaction system 106, or components of any of thereof performing operations, any suitable system or components of the system may perform one or more operations of the method 200. For example, one or more operations of method 200 may be implemented, at least in part, in the form of software instructions (e.g., software instructions 120 of FIG. 1), stored on non-transitory, tangible, machine-readable media (e.g., memory 110 of FIG. 1) that when run by one or more processors (e.g., processors 108 of FIG. 1) may cause the one or more processors to perform operations 202-242.

After start, interaction system 106 receives an input file 104 from a source system 102 at operation 202. Input file 104 may include data from multiple sources, such as user information and interaction data.

At operation 204, interaction system 106 executes the generative AI model 116 over the input file 104 to generate a descriptive output 122. Before executing the generative AI model 116, interaction system 106 may preprocess input file 104, such as conducting file validation (e.g., checking format or compatibility) and embedding input file 104 into a feature representation. Interaction system 106 may additionally perform operations such as parsing (extracting content from input file 104). In an embodiment, the descriptive output 122 may include an indication of a first cloud application to invoke and triggers 126 to be activated on the first cloud application 134. In an embodiment, generative AI model 116 is trained to determine what cloud application should be invoked, along with triggers 126 to be activated. Generative AI model 116 is trained on labeled training datasets where applications and triggers 126 are explicitly linked to interactions.

At operation 206, interaction system 106 transmits the input file 104 to the first cloud application 134. The first cloud application 134 may be operating on a cloud computing system 130. Cloud computing system 130 may provide network services via the first cloud application 134 and other cloud applications.

At operation 208, interaction system 106 activates the triggers 126 on the first cloud application 134. In an embodiment, the triggers 126 are configured to cause the first cloud application 134 to execute operations 136 on input file 104. The results of operation executions may be stored in database 118.

At operation 210, interaction system 106 determines whether a data interaction 138 is activated by the first cloud application 134 upon completing the execution of the operations 136. In an embodiment, a data interaction module within the first cloud application 134 may be activated by the data interaction 138. The activation of data interaction module may further invoke the generative AI model 116 of interaction system 106.

If no data interaction 138 is activated, method 200 then ends at operation 212. In an embodiment, the results of operation execution may be returned from the first cloud application 134 to interaction system 106. Interaction system 106 may further transmit the results of operation execution to source system 102.

If a data interaction 138 is activated, interaction system 106 executes the generative AI model 116 over the data interaction 138 to generate a secured computer program 144 at operation 214. In an embodiment, interaction system 106 may preprocess the data interaction 138 before executing the generative AI model 116. For example, the preprocessing may include denoising and normalization. Generative AI model 116 is trained to determine a target cloud application 140 and a relevant approver 162 when data interaction 138 is to be shared from the first cloud application 134 to the target cloud application 140. Generative AI model 116 may be trained on a large-scale of training dataset including, e.g., historical approval workflows, user data, user data profile, data type, triggers, and approver types/roles.

In an embodiment, the secured computer program 144 may include an indication of a second cloud application (i.e., a target cloud application 140) to invoke by the data interaction 138. The secured computer program 144 may also include an identifier of an approver 162 associated with the second cloud application 140. The secured computer program 144 may additionally include and rules 148 and actions associated with the data interaction 138. In an embodiment, the secured computer program 144 operates on a blockchain network 150.

At operation 216, interaction system 106 executes a hashing algorithm 112 to generate a first hash 156a for the data interaction 138.

At operation 218, interaction system 106 encrypts the data interaction 138 by encrypting the first hash 156a using a private key 114. Encrypting the data interaction 138 by hashing algorithm 112 and private key 114 can improve security of data interaction 138 when data interaction 138 is being validated on blockchain network 150.

At operation 220, interaction system 106 transmits the encrypted data interaction 142 to the secured computer program 144 to cause an automatic execution of the secured computer program 144 on the blockchain network 150. The automatic execution may follow the rules 148. In an embodiment, the automatic execution of secured computer program 144 may lead to validation 158 of the sharing of data interaction 138.

At operation 222, interaction system 106 decrypts the encrypted data interaction 142 using a public key 154 to generate a second hash 156b.

At operation 224, interaction system 106 determines whether the second hash 156b matches the first hash 156a.

If the second hash 156b does not match the first hash 156a (which means the sharing of data interaction 138 is not validated), interaction system 106 declines the data interaction 138 to invoke the second cloud application 140 at operation 226. Method 200 then ends at operation 228. In an embodiment, the status of declining the data interaction 138 to invoke the second cloud application 140 and the reason may be stored in database 118. Interaction system 106 may further transmit the status of declining the data interaction 138 to invoke the second cloud application 140 and the reason to source system 102.

If the second hash 156b matches the first hash 156a, interaction system 106 validates the encrypted data interaction 142 at operation 230.

At operation 232, interaction system 106 transmits to a user device 160 associated with the approver 162 based on the identifier, a request for an approval of invoking the second cloud application 140 to execute the data interaction 138.

At operation 234, interaction system 106 determines whether there is an approval from the approver 162. The approval may specify that the data interaction 138 is allowed to invoke the second cloud application 140 for execution.

If there is no approval from the approver 162, interaction system 106 declines the data interaction 138 to invoke the second cloud application 140 at operation 236. Method 200 then ends at operation 238. In an embodiment, the status of declining the data interaction 138 to invoke the second cloud application 140 and the reason may be stored in database 118. Interaction system 106 may further transmit the status of declining the data interaction 138 to invoke the second cloud application 140 and the reason to source system 102.

If there is an approval from the approver 162, interaction system 106 transmits the data interaction 138 to the second cloud application 140 for execution at operation 240. The second cloud application 140 may then execute the data interaction 138. The results of data interaction 138 by the second cloud application 140 may be returned to the first cloud application 134. In an embodiment, the first cloud application 134 may perform further operations 136 based on execution results from the second cloud application 140. The execution results from both the first cloud application 134 and second cloud application 140 may be stored in database 118. Interaction system 106 may further transmit the execution results to source system 102.

Method 200 then ends at operation 242.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “operation for” are explicitly used in the particular claim.

1. A system, comprising:
a memory operable to store:
a hashing algorithm;
a private key; and
a generative artificial-intelligence (AI) model; and
a processor, operably coupled to the memory, and configured to:
receive, from a source system, an input file;
execute the generative AI model on the input file to generate a descriptive output, the descriptive output comprising an indication of a first cloud application to invoke, wherein the first cloud application operates on a cloud computing system;
transmit the input file to the first cloud application;
detect an activation of a data interaction by the first cloud application;
execute the generative AI model on the data interaction to generate a structured output, the structured output comprising an indication of a second cloud application to invoke by the data interaction and one or more rules associated with the data interaction, wherein the second cloud application operates on the cloud computing system;
generate a secured computer program by translating the structured output into code of the secured computer program using a programming language, wherein the secured computer program operates on a blockchain network;
execute the hashing algorithm and the private key to encrypt the data interaction;
transmit the encrypted data interaction to the secured computer program to execute the secured computer program on the blockchain network using the one or more rules, wherein the execution comprises validating the encrypted data interaction; and
responsive to determining the encrypted data interaction is validated, transmit the data interaction to the second cloud application for execution.

2. The system of claim 1, wherein the descriptive output further comprises one or more triggers to be activated on the first cloud application.

3. The system of claim 2, wherein the processor is further configured to:
activate the one or more triggers on the first cloud application, wherein the one or more triggers are configured to cause the first cloud application to execute one or more operations and activate the data interaction upon completing the execution of the one or more operations.

4. The system of claim 1, wherein the processor is further configured to:
execute the hashing algorithm on the data interaction to generate a first hash for the data interaction; and
encrypt the data interaction by encrypting the first hash using the private key.

5. The system of claim 4, wherein validating the encrypted data interaction comprises:
decrypting the encrypted data interaction using a public key to generate a second hash;
comparing the first hash with the second hash; and
validating the encrypted data interaction upon determining the first hash matches the second hash.

6. The system of claim 5, wherein the secured computer program further comprises an identifier of an approver associated with the second cloud application, and wherein the processor is further configured to:
transmit, to a user device associated with the approver based on the identifier, a request for an approval of invoking the second cloud application to execute the data interaction upon validating the encrypted data interaction; and
transmit the data interaction to the second cloud application for execution upon detecting the approval from the approver.

7. The system of claim 1, wherein the memory is further operable to store a database, wherein the processor is further configured to:
store the descriptive output in the database.

8. A method, comprising:
receiving, from a source system, an input file;
executing a generative artificial-intelligence (AI) model on the input file to generate a descriptive output, the descriptive output comprising an indication of a first cloud application to invoke, wherein the first cloud application operates on a cloud computing system;
transmitting the input file to the first cloud application;
detecting an activation of a data interaction by the first cloud application;
executing the generative AI model on the data interaction to generate a structured output, the structured output comprising an indication of a second cloud application to invoke by the data interaction and one or more rules associated with the data interaction, wherein the second cloud application operates on the cloud computing system;
generating a secured computer program by translating the structured output into code of the secured computer program using a programming language, wherein the secured computer program operates on a blockchain network;
executing a hashing algorithm and a private key to encrypt the data interaction;
transmitting the encrypted data interaction to the secured computer program to execute the secured computer program on the blockchain network using the one or more rules, wherein the execution comprises validating the encrypted data interaction; and
responsive to determining the encrypted data interaction is validated, transmitting the data interaction to the second cloud application for execution.

9. The method of claim 8, wherein the descriptive output further comprises one or more triggers to be activated on the first cloud application.

10. The method of claim 9, further comprising:
activating the one or more triggers on the first cloud application, wherein the one or more triggers are configured to cause the first cloud application to execute one or more operations and activate the data interaction upon completing the execution of the one or more operations.

11. The method of claim 8, further comprising:
executing the hashing algorithm on the data interaction to generate a first hash for the data interaction; and
encrypting the data interaction by encrypting the first hash using the private key.

12. The method of claim 11, wherein validating the encrypted data interaction comprises:
decrypting the encrypted data interaction using a public key to generate a second hash;
comparing the first hash with the second hash; and
validating the encrypted data interaction upon determining the first hash matches the second hash.

13. The method of claim 12, wherein the secured computer program further comprises an identifier of an approver associated with the second cloud application, and wherein the method further comprises:
transmitting, to a user device associated with the approver based on the identifier, a request for an approval of invoking the second cloud application to execute the data interaction upon validating the encrypted data interaction; and
transmitting the data interaction to the second cloud application for execution upon detecting the approval from the approver.

14. The method of claim 8, further comprising:
storing the descriptive output in a database.

15. A non-transitory computer-readable medium storing instructions that, when executed by one or more processors of a system, cause the one or more processors to:
receive, from a source system, an input file;
execute a generative artificial-intelligence (AI) model on the input file to generate a descriptive output, the descriptive output comprising an indication of a first cloud application to invoke, wherein the first cloud application operates on a cloud computing system;
transmit the input file to the first cloud application;
detect an activation of a data interaction by the first cloud application;
execute the generative AI model on the data interaction to generate a structured output, the structured output comprising an indication of a second cloud application to invoke by the data interaction and one or more rules associated with the data interaction, wherein the second cloud application operates on the cloud computing system;
generate a secured computer program by translating the structured output into code of the secured computer program using a programming language, wherein the secured computer program operates on a blockchain network;
execute a hashing algorithm and a private key to encrypt the data interaction;
transmit the encrypted data interaction to the secured computer program to execute the secured computer program on the blockchain network using the one or more rules, wherein the execution comprises validating the encrypted data interaction; and
responsive to determining the encrypted data interaction is validated, transmit the data interaction to the second cloud application for execution.

16. The non-transitory computer-readable medium of claim 15, wherein the descriptive output further comprises one or more triggers to be activated on the first cloud application.

17. The non-transitory computer-readable medium of claim 16, wherein the instructions further cause the processor to:
activate the one or more triggers on the first cloud application, wherein the one or more triggers are configured to cause the first cloud application to execute one or more operations and activate the data interaction upon completing the execution of the one or more operations.

18. The non-transitory computer-readable medium of claim 15, wherein the instructions further cause the processor to:
execute the hashing algorithm on the data interaction to generate a first hash for the data interaction; and
encrypt the data interaction by encrypting the first hash using the private key.

19. The non-transitory computer-readable medium of claim 18, wherein validating the encrypted data interaction comprises:
decrypting the encrypted data interaction using a public key to generate a second hash;
comparing the first hash with the second hash; and
validating the encrypted data interaction upon determining the first hash matches the second hash.

20. The non-transitory computer-readable medium of claim 19, wherein the secured computer program further comprises an identifier of an approver associated with the second cloud application, and wherein the instructions further cause the processor to:
transmit, to a user device associated with the approver based on the identifier, a request for an approval of invoking the second cloud application to execute the data interaction upon validating the encrypted data interaction; and
transmit the data interaction to the second cloud application for execution upon detecting the approval from the approver.
